(19) United States
(12) Patent Application Publication
(10) Pub. No.: US 2011/0287675 A1
(43) Pub. Date: Nov. 24, 2011

(54) VAPOR-INSULATING WALL CLADDING

(76) Inventor: Stephan Wedi, Emsdetten (DE)

(21) Appl. No.: 13/102,163

(22) Filed: May 6, 2011

(30) Foreign Application Priority Data
May 18, 2010 (DE) 20 2010 006 938.6

(51) Int. Cl. B32B 13/02; B32B 15/14; B32B 5/24; B32B 5/02

(52) U.S. Cl. 442/1; 442/232; 442/316; 442/378; 442/222; 442/315; 442/371

(57) ABSTRACT

The invention relates to a vapor-insulating wall cladding (100), comprising aluminum foil (4) that acts as a vapor barrier, the foil being joined to a plaster base layer (3), characterized in that the plaster base layer (3) comprises a fiber layer (1), namely a non-woven fabric, woven fabric, knitted fabric or applied scrim coat, which is bound by a flexibly cured mortar (2), which joins the fiber layer to the aluminum foil and has the characteristics of plaster mortar.

The invention relates to a vapor-insulating wall cladding, comprising aluminum foil that acts as a vapor barrier, the foil being joined to a plaster base layer.

From the documents of utility model DE 1 995 154, an insulating board is known, in which the core of a board made of rigid foam is coated, on one side, with impermeable aluminum foil acting as a vapor barrier and, on the other side, with a plaster base. The plaster base can be a wood wool cement board, for example.

Overall, this is a rigid, thick-layered board, in which the aluminum foil is joined indirectly to the plaster base by way of the rigid foam board. This is therefore a rigid element in the form of a building board.

In contrast, an object of the invention is to provide a wall cladding that is very thin in the overall and can be glued to a wall or another planar base in the same manner as wallpaper.

This object is achieved by a vapor-insulated wall cladding, wherein the plaster base layer comprises a fiber coat, namely a non-woven fabric, woven fabric, knitted fabric or applied scrim coat made of hydrophilic fibers, which is bound by a flexibly cured mortar, which joins the fiber coat to the aluminum foil and has the characteristics of plaster mortar.

The wall cladding is flexible, rolled as a web, and handled in a manner similar to wallpaper. It can therefore be referred to as “plaster wallpaper”. It should be emphasized that the plaster base layer, in contrast to the prior art, also forms a thin, preferably ≦5 mm thick plaster layer, which can be produced industrially using exactly the same composition and can therefore be used directly as a plaster layer under the same conditions.

So as to simplify attachment, the aluminum foil is covered on the side facing away from the plaster base layer with an adhesive coating.

In a preferably selected embodiment, the thickness of the aluminum foil ranges between 0.01 and 1 mm, and the thickness of the mortar layer comprising the enclosed fiber coat ranges between 0.03 and 4 mm. The total height therefore ranges between 0.4 and 5 mm in the case of conventional application.

Hydrophilic fibers, which are “water-loving” in the literal sense of the term, are characterized in that they have an attracting interaction with water. Even with a very thin plaster base layer, they produce an intimate bond between the fibers and mortar. Preferably, fibers that are water-insoluble are selected. The mortar used is typically a mixture of 50 to 90 wt % cement with superfine-grained fillers and 10 to 50 wt % of elastifying synthetic materials that are naturally dispersible in water. In this regard, it is essential that the fibers do not repel the water that is stirred in. Also the elastifying material is dispersible in the mortar slurry.

The hydrophilic fibers are selected from the group consisting of glass fibers, cellulose fibers and/or hydrophilized synthetic fibers, and in all cases the fibers are insoluble in water.

Furthermore, it is proposed to produce a heat-insulating wall cladding structure using the aforementioned wall cladding by joining a heat-insulating panel, and more particularly a foamed synthetic material board, to a vapor-insulated wall cladding of the type described above. The wall cladding is glued to the hot side of the panel with the aluminum side facing inward.

To this end, an adhesive joining coating is also used.

One embodiment of the invention is shown in the drawings below. The figures in the drawings show:

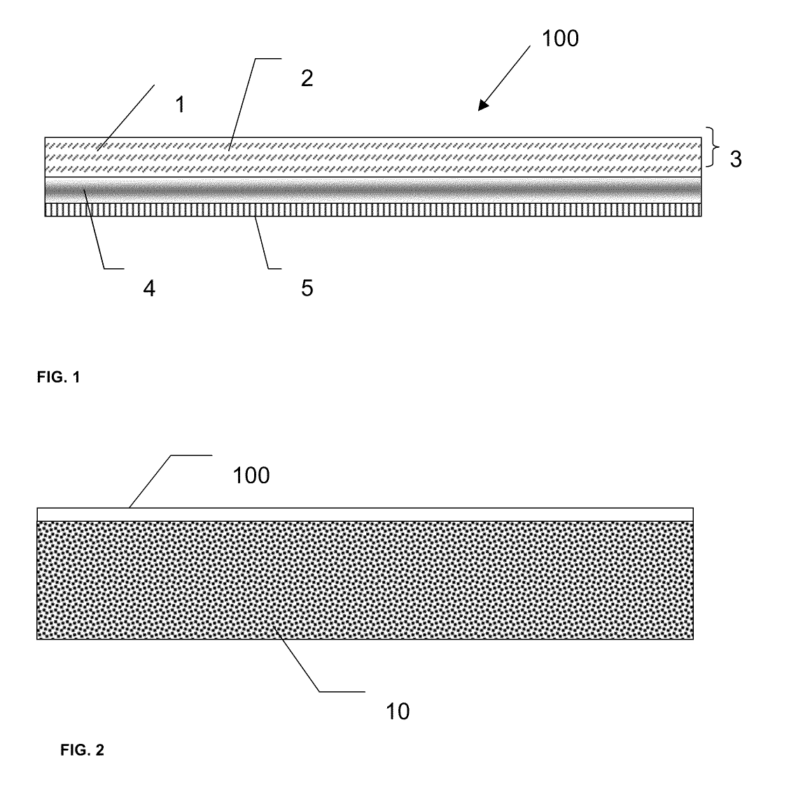

FIG. 1: an enlarged sectional view of a vapor-insulated wall cladding according to the invention; and

FIG. 2: an expanded wall cladding structure using the wall cladding of FIG. 1.

FIG. 1 shows a cross-section of the layer structure of a vapor-insulated wall cladding 100. The total thickness in the embodiment is between 0.3 and 5 mm.

The wall cladding comprises two layers, which is to say an aluminum foil 4 and a combined fiber coat 1 including mortar 2 therein, which form a plaster base layer 3.

A fiber coat 1 in the form of a non-woven fabric made of glass fibers is applied to aluminum foil 4 that is approximately 0.1 mm thick. The fibers 4 are bound in flexibly cured mortar 2 and intimately glued to the aluminum foil 4, together with the mortar. No additional adhesive coating is used between the mortar and aluminum.

The mortar 2 is composed of a cured compound comprising 50 to 90 wt % cement with superfine-grained fillers and 10 to 50 wt % of elastifying synthetic materials that are naturally dispersible in water. “Superfine-grained fillers” shall be understood as granular fillers and additives, such as quartz powder, having a particle size such as to pass through a square mesh opening of less than 0.2 mm. However, so as not to significantly degrade the binding power, processing characteristics and water drainage, this should not exclusively comprise superfine dust. Suitable fillers also include other known additives such as titanium dioxide, aluminum oxide or mixtures of such substances. Together, the fiber coat 1 and mortar 2 form a plaster base layer 3.

Other mortar mixtures that are suited for technical use are disclosed in EP 871 810 B1, for example.

“Aluminum foils” shall be interpreted as foils that are typically made of an aluminum alloy and are also referred to as light alloy metal foils. They have a content of more than 80 wt % of aluminum.

If the wall cladding 100 is used alone, the aluminum foil side is glued to a wall, a component or the like. Epoxy resin-based adhesives are suitable for this purpose. The gluing and transport of the foil can be simplified if an adhesive coating 5 comprising a release film (not shown) is applied so as to cover the exterior. After pulling off the release film, the adhesive coating 5 can be applied directly to virtually any wall surface that is dust-free.

The vapor-insulating wall cladding 100 can also be integrally joined to a heat-insulating panel 10, as is shown in FIG. 2. This is notably a foamed synthetic material board made of polystyrene or polyurethane, such as are sold, for example, as “WEDI boards”. The vapor-insulating wall cladding 100 is glued to the hot side of the panel, with an adhesive intermediate layer therebetween, which is not shown separately here.

Because aluminum foil 4 is located between the foamed synthetic material board and the plaster base layer 3 of the wall cladding 100, and a further coating, for example tile or ceramic tile, is applied, whereby vapor-blocking walls such as are required in wet rooms and the like, can be produced in a simple manner.

It is also possible to produce different layer structures, wherein the wall cladding 100 is disposed, for example, between two foamed synthetic material boards.

1. A vapor-insulating wall cladding (100), comprising an aluminum foil (4) that acts as a vapor barrier, the foil being joined to a plaster base layer (3), characterized in that the plaster base layer (3) comprises a fiber layer (1), namely a non-woven fabric, woven fabric, knitted fabric or applied scrim coat made of hydrophilic fibers, which is bound by a flexibly cured mortar (2), which joins the fiber coat to the aluminum foil and has the characteristics of plaster mortar.

2. The wall cladding according to claim 1, characterized in that the aluminum foil (4) is covered with an adhesive coating (5) on the side facing away from the plaster base layer (3).

3. The wall cladding according to claim 1, characterized in that the hydrophilic fibers are water-insoluble and selected from the group consisting of glass fibers, cellulose fibers and/or hydrophilized synthetic fibers.

4. A wall cladding according to claim 1, characterized in that the mortar 2 comprises 50 to 90 wt % cement containing superfine-grained fillers and 10 to 50 wt % of elastifying synthetic materials that are dispersible in water of the mortar slurry.

5. A wall cladding according to claim 1, characterized in that the thickness of the aluminum foil (4) ranges between 0.01 and 1 mm.

6. A wall cladding according to claim 1, characterized in that the thickness of the mortar layer (2) comprising an enclosed fiber coat (1) ranges between 0.4 and 5 mm.

7. A heat-insulating wall cladding structure, characterized in that a heat-insulating panel (10), and more particularly a foamed synthetic material board, is joined to a vapor-insulating wall cladding (100) according to claim 1 on the hot side of the panel (10).

8. The heat-insulating wall cladding structure according to claim 7, characterized in that the aluminum foil (4) of the wall cladding is joined to the heat-insulating panel by an adhesive bonding layer.
